(19) United States
(12) Patent Application Publication
(10) Pub. No.: US 2025/0361002 A1
(43) Pub. Date: Nov. 27, 2025

(54) INTEGRATED ACTIVE SIDESTICK AND FLY-BY-WIRE

(71) Applicant: Rockwell Collins, Inc., Cedar Rapids, IA (US)

(72) Inventors: John W. Roltgen, Cedar Rapids, IA (US); Matthew G. Poellet, Cedar Rapids, IA (US); Douglas R. Johnson, Cedar Rapids, IA (US); Nuri R. Eady, Cedar Rapids, IA (US); Thomas A. Letarte, Cedar Rapids, IA (US)

(21) Appl. No.: 18/670,082

(22) Filed: May 21, 2024

(51) Int. Cl. B64C 13/04; B64C 13/50

(52) U.S. Cl. CPC B64C 13/042; B64C 13/503

(57) ABSTRACT

A flight control system may include active sidesticks with active sidestick computers which may execute flight control functions to determine control surface commands for remote electronic units. The active sidesticks may also include remote data concentrators which concentrate digital data for processing by the active sidestick computers. The flight control system may also include additional remote data concentrators and flight control computers which are located outside of the active sidesticks. The flight control computers may also generate the control surface commands for the remote electronic units.

### TECHNICAL FIELD

The present disclosure generally relates to control systems or transmitting systems for actuating flying-control surfaces, lift-increasing flaps, air brakes, or spoilers, and more specifically to fly-by-wire.

### BACKGROUND

Use of Fly-By-Wire (FBW) systems is widespread in aviation. Today, most of the pilot controls that interface to the FBW systems are either a column, wheel, pedal type, or a passive sidestick. Flight control computers and/or actuation control electronics (ACEs) execute functions of the FBW systems. The flight control computers and/or actuation control electronics (ACEs) all contribute to the size, weight, and/or power of the aircraft. Therefore, it would be advantageous to provide a device, system, and method that reduces size, weight, and/or power.

### SUMMARY

In some aspects, the techniques described herein relate to a flight control system including: a first active sidestick including: a first control stick; a first pilot sensor configured to sense a first analog position of the first control stick; and a first active sidestick computer; a second active sidestick including: a second control stick; a second pilot sensor configured to sense a second analog position of the second control stick; and a second active sidestick computer; a first flight control computer; and a second flight control computer, wherein the first active sidestick computer, the second active sidestick computer, the first flight control computer, and the second flight control computer are configured to receive one or more digital packets and process the one or more digital packets to generate one or more control surface commands.

In some aspects, the techniques described herein relate to a flight control system, including: a first type-A remote data concentrator; a first type-B remote data concentrator; a second type-A remote data concentrator; and a second type-B remote data concentrator, wherein the first type-A remote data concentrator, the second type-A remote data concentrator, the first type-B remote data concentrator, and the second type-B remote data concentrator are configured to convert the first analog position of the first control stick and the second analog position of the second control stick to digital positions and concentrate the digital positions into the one or more digital packets.

In some aspects, the techniques described herein relate to a flight control system, wherein the first type-A remote data concentrator, the second type-A remote data concentrator, the first type-B remote data concentrator, and the second type-B remote data concentrator are configured to send the one or more digital packets to the first active sidestick computer, the second active sidestick computer, the first flight control computer, and the second flight control computer.

In some aspects, the techniques described herein relate to a flight control system, wherein the first active sidestick includes the first type-A remote data concentrator; wherein the second active sidestick includes the second type-A remote data concentrator.

In some aspects, the techniques described herein relate to a flight control system, wherein the first type-B remote data concentrator and the second type-B remote data concentrator are disposed outside of the first active sidestick and the second active sidestick.

In some aspects, the techniques described herein relate to a flight control system, wherein the first pilot sensor and the second pilot sensor are configured to send the first analog position of the first control stick and the second analog position of the second control stick, respectively, to each of the first type-A remote data concentrator, the second type-A remote data concentrator, the first type-B remote data concentrator, and the second type-B remote data concentrator.

In some aspects, the techniques described herein relate to a flight control system, wherein the first type-A remote data concentrator, the second type-A remote data concentrator, the first type-B remote data concentrator, and the second type-B remote data concentrator are configured to receive additional data and concentrate the additional data into the one or more digital packets.

In some aspects, the techniques described herein relate to a flight control system, wherein the first active sidestick computer, the second active sidestick computer, the first flight control computer, and the second flight control computer each include a command processor and a monitor processor, wherein the command processor and the monitor processor are configured to process the one or more digital packets to generate the one or more control surface commands.

In some aspects, the techniques described herein relate to a flight control system, wherein the command processor of the first active sidestick computer and the second active sidestick computer are type-A processors, wherein the monitor processor of the first active sidestick computer and the second active sidestick computer are type-B processors, wherein the command processor of the first flight control computer and the second flight control computer are type-C processors, wherein the monitor processor of the first flight control computer and the second flight control computer are type-D processors.

In some aspects, the techniques described herein relate to a flight control system, wherein the command processor of the first active sidestick computer and the second active sidestick computer and monitor processor of the first active sidestick computer and the second active sidestick computer are type-A processors, wherein the command processor of the first flight control computer and the second flight control computer and the monitor processor of the first flight control computer and the second flight control computer are type-B processors.

In some aspects, the techniques described herein relate to a flight control system, wherein at least one of the first active sidestick computer, the second active sidestick computer, the first flight control computer, or the second flight control computer comprise an additional processor, wherein the command processor, the monitor processor, and the additional processor are in a triplex configuration.

In some aspects, the techniques described herein relate to a flight control system, wherein the first active sidestick computer, the second active sidestick computer, the first flight control computer, and the second flight control computer each include a comparator, wherein the comparator is configured to compare the one or more control surface commands generated by the command processor and the monitor processor to determine one of a valid-compare or a mis-compare.

In some aspects, the techniques described herein relate to a flight control system, wherein the first active sidestick computer, the second active sidestick computer, the first flight control computer, and the second flight control computer are configured to output the one or more control surface commands generated by the command processor upon determining the valid-compare.

In some aspects, the techniques described herein relate to a flight control system, wherein the first active sidestick computer, the second active sidestick computer, the first flight control computer, and the second flight control computer do not output the one or more control surface commands generated the command processor upon determining the mis-compare.

In some aspects, the techniques described herein relate to a flight control system, wherein the comparator is configured to switch open an output from the command processor upon determining the mis-compare and switch closed the output from the command processor upon determining the valid-compare; wherein the command processor and the monitor processor are configured to receive feedback of whether the output from the command processor is closed or open.

In some aspects, the techniques described herein relate to a flight control system, including: a plurality of type-A remote electronic units, wherein the plurality of type-A remote electronic units are configured to receive the one or more control surface commands from at least one of the active sidestick computers or the flight control computers; a plurality of type-B remote electronic units, wherein the plurality of type-B remote electronic units are configured to receive the one or more control surface commands from at least one of the active sidestick computers or the flight control computers; and a plurality of control surfaces, wherein the plurality of type-A remote electronic units and of the plurality of type-B remote electronic units are configured to drive actuators of the plurality of control surfaces based on the one or more control surface commands.

In some aspects, the techniques described herein relate to a flight control system, wherein the first active sidestick computer and the second active sidestick computer are configured to send the one or more control surface commands to one or more of the plurality of type-A remote electronic units; wherein the first flight control computer and the second flight control computer are configured to send the one or more control surface commands to one or more of the plurality of type-B remote electronic units.

In some aspects, the techniques described herein relate to a flight control system, wherein the actuators of the plurality of control surfaces are driven by one or more of the plurality of type-A remote electronic units or one or more of the plurality of type-B remote electronic units.

me aspects, the techniques described herein relate to a flight control system including: a plurality of control surfaces, wherein the active sidestick computers and the flight control computers are configured to drive actuators of the plurality of control surfaces based on the one or more control surface commands.

In some aspects, the techniques described herein relate to a flight control system including: a first active sidestick including: a first control stick; a first pilot sensor configured to sense a first analog position of the first control stick; and a first active sidestick computer; a second active sidestick including: a second control stick; a second pilot sensor configured to sense a second analog position of the second control stick; and a second active sidestick computer; a first flight control computer; a second flight control computer, wherein the first active sidestick computer, the second active sidestick computer, the first flight control computer, and the second flight control computer are configured to receive one or more digital packets and process the one or more digital packets to generate one or more control surface commands; a first type-A remote data concentrator; a first type-B remote data concentrator; a second type-A remote data concentrator; a second type-B remote data concentrator, wherein the first type-A remote data concentrator, the second type-A remote data concentrator, the first type-B remote data concentrator, and the second type-B remote data concentrator are configured to convert the first analog position of the first control stick and the second analog position of the second control stick to digital positions and concentrate the digital positions into the one or more digital packets; a plurality of type-A remote electronic units; a plurality of type-B remote electronic units, wherein pairs of the plurality of type-A remote electronic units and of the plurality of type-B remote electronic units are configured to receive the one or more control surface commands from respective of the active sidestick computers and the flight control computers; and a plurality of control surfaces, wherein the pairs of the plurality of type-A remote electronic units and of the plurality of type-B remote electronic units drive respective of the plurality of control surfaces based on the one or more control surface commands.

In some aspects, the function of the remote electronics units may be integrated into the active sidesticks, the flight control computers, the remote data concentrators, or any combination thereof. In this case, the active sidesticks, flight control computers, and/or remote data concentrators will provide analog signals to control actuators of the control surfaces.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A depicts an architecture of a flight control system, in accordance with one or more embodiments of the present disclosure.

FIG. 1B depicts a view of active sidestick computers and flight control computers of the flight control system, in accordance with one or more embodiments of the present disclosure.

FIG. 2 depicts an architecture of the flight control system, in accordance with one or more embodiments of the present disclosure.

FIG. 3 depicts a view of active sidestick computers and flight control computers of the flight control system, in accordance with one or more embodiments of the present disclosure.

FIG. 4 depicts an architecture of the flight control system, in accordance with one or more embodiments of the present disclosure.

FIG. 5 depicts an architecture of the flight control system, in accordance with one or more embodiments of the present disclosure.

FIG. 6 depicts an architecture of the flight control system, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure are generally directed to an integrated active sidestick and fly-by-wire. A flight control system may include active sidesticks with active sidestick computers which may execute flight control functions to determine control surface commands for remote electronic units. The active sidesticks may also include remote data concentrators which concentrate digital data for processing by the active sidestick computers. The remote data concentrators may also convert analog data to digital data for use by active sidestick computers and/or flight control computers. The flight control system may also include additional remote data concentrators and flight control computers which are located outside of the active sidesticks. The flight control computers may also generate the control surface commands for the remote electronic units.

U.S. Patent Number U.S. Pat. No. 7,878,461B2, titled “System and method for an integrated backup control system”; U.S. Patent Publication Number US20030127569A1, titled “Aircraft flight surface control system”; U.S. Patent Number U.S. Pat. No. 8,690,101B2, titled “Triplex cockpit control data acquisition electronics”; U.S. Patent Number U.S. Pat. No. 8,235,328B2, titled “Apparatus and method for backup control in a distributed flight control systems; are incorporated herein by reference in the entirety.

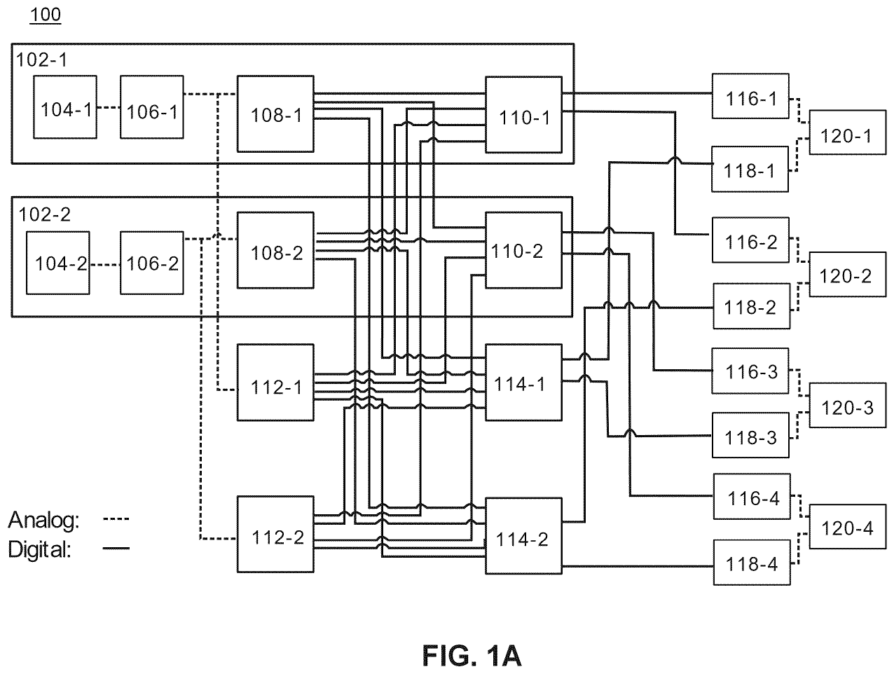

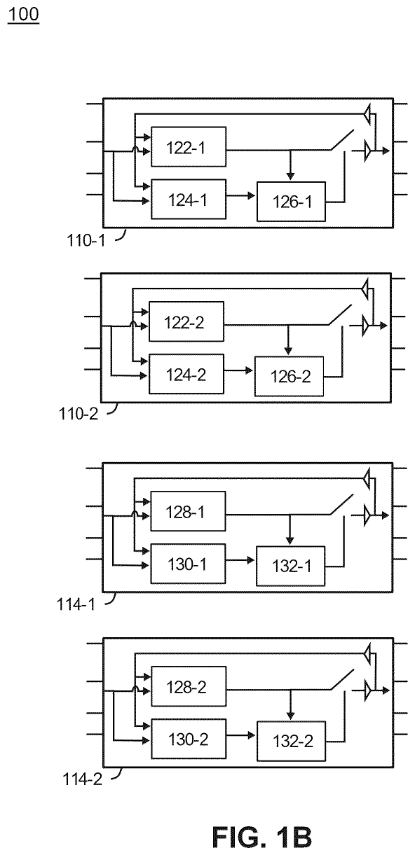

FIGS. 1A-1B depict a flight control system 100, in accordance with one or more embodiments of the present disclosure. The flight control system 100 may also be referred to as a fly-by-wire (FBW) flight control system. The flight control system 100 may be a flight control system of an aircraft. The flight control system 100 may include active sidesticks 102, control sticks 104, pilot sensors 106, remote data concentrators 108, active sidestick computers 110, remote data concentrators 112, flight control computers 114, remote electronic units 116, remote electronic units 118, control surfaces 120, and the like.

The active sidesticks 102 are located within a cockpit of an aircraft. The active sidesticks 102 may include the control sticks 104, the pilot sensors 106, the remote data concentrators 108, and/or the active sidestick computers 110. The flight control system 100 may include two of the active sidesticks 102 (e.g., a first active sidestick 102-1, a second active sidestick 102-2). For example, a first active sidestick 102-1 may be a captain active sidestick and a second active sidestick 102-2 may be a first officer active sidestick, or vice versa. Each of the first active sidestick 102-1 and the second active sidestick 102-2 may include the control sticks 104, the pilot sensors 106, the remote data concentrators 108, and/or the active sidestick computers 110. For example, the first active sidestick 102-1 may include a first control stick 104-1, first pilot sensor 106-1, first remote data concentrator 108-1, and/or first active sidestick computer 110-1. By way of another example, second active sidestick 102-2 may include a second control stick 104-2, second pilot sensor 106-2, second remote data concentrator 108-2, and/or second active sidestick computer 110-2.

The pilot sensors 106 may include linear-variable-displacement transducers (LVDT), rotary-variable-displacement-transducers (RVDT), or the like. For example, each of the first pilot sensor 106-1 and the second pilot sensor 106-2 may include multiple pitch RVDTs and multiple roll RVDTs.

The pilot sensors 106 may be coupled to the control sticks 104. The pilot sensors 106 may sense the analog position of the control sticks 104. For example, the first pilot sensor 106-1 and the second pilot sensor 106-2 may sense the analog position of the first control stick 104-1 and the second control stick 104-2, respectively.

The pilot sensors 106 may send the analog position of the control sticks 104 to one or more components of the flight control system 100. The pilot sensors 106 may send the analog position of the control sticks 104 to the remote data concentrators 108 and/or the remote data concentrators 112. For example, the first pilot sensor 106-1 may send the analog position of the first control stick 104-1 to each of the remote data concentrators 108 (e.g., first remote data concentrator 108-1, second remote data concentrator 108-2) and/or the remote data concentrators 112 (e.g., first remote data concentrator 112-1, second remote data concentrator 112-2). For instance, the first pilot sensor 106-1 may include four pitch RVDTs and four roll RVDTs, where the four pitch RVDTs and the four roll RVDTs may each send the analog measurements to respective of the first remote data concentrator 108-1, second remote data concentrator 108-2, the first remote data concentrator 112-1, and the second remote data concentrator 112-2. By way of another example, the second pilot sensor 106-2 may send the analog position of the second control stick 104-2 to each of the remote data concentrators 108 (e.g., first remote data concentrator 108-1, second remote data concentrator 108-2) and/or the remote data concentrators 112 (e.g., first remote data concentrator 112-1, second remote data concentrator 112-2). For instance, the second pilot sensor 106-2 may include four pitch RVDTs and four roll RVDTs, where the four pitch RVDTs and the four roll RVDTs may each send the analog measurements to respective of the first remote data concentrator 108-1, second remote data concentrator 108-2, the first remote data concentrator 112-1, and the second remote data concentrator 112-2.

The remote data concentrators 108 may be disposed within the active sidesticks 102. Each of the active sidesticks 102 may include one of the remote data concentrators 108. For example, the first active sidestick 102-1 may include the first remote data concentrator 108-1 and the second active sidestick 102-2 may include the second remote data concentrator 108-2.

The remote data concentrators 112 may be disposed outside of the active sidesticks 102. The remote data concentrators 112 may include first remote data concentrator 112-1 and second remote data concentrator 112-2. Thus, the flight control system 100 may include two of the remote data concentrators 108 and two of the remote data concentrators 112.

The flight control system 100 may include one or more analog buses connecting between the pilot sensors 106, the remote data concentrators 108, and/or the remote data concentrators 112. The pilot sensors 106 may be connected to the remote data concentrators 108 and the remote data concentrators 112 by analog buses.

Each of the remote data concentrators 108 and each of the remote data concentrators 112 may receive the analog position of the control sticks 104 from the pilot sensors 106. For example, each of the remote data concentrators 108 and each of the remote data concentrators 112 may receive the analog position of the first control stick 104-1 and the second control stick 104-2 from the first pilot sensor 106-1 and the second pilot sensor 106-2, respectively.

The remote data concentrators 108 and the remote data concentrators 112 may convert the analog position to a digital position. The remote data concentrators 108 and the remote data concentrators 112 may include analog-to-digital converters for converting the analog position to the digital position.

Each of the remote data concentrators 108 and each of the remote data concentrators 112 may also receive additional data (e.g., additional digital data and/or analog data). The additional data may include, but is not limited to, electronic signals from aircraft sensors providing information related to the aircraft's speed, altitude, angle of attack, air data system data, inertial reference system data, instrument landing system data, accelerometer data, compass data, magnetometer data, clinometer data, pressure sensor data, positioning sensor data, strain gauge data, heat sensor data (e.g., total air temperature (TAT) probe data), weight on wheels, switches on the control stick (e.g. autopilot disconnect, trim, etc.) and the like. Where the additional data includes additional analog data, the remote data concentrators 108 and of the remote data concentrators 112 may convert the additional analog data into additional digital data. The remote data concentrators 108 and remote data concentrators 112 may make the additional data available to the active sidestick computers 110 and flight control computers 114.

The remote data concentrators 108 and the remote data concentrators 112 may concentrate the digital position and the additional data into digital packets. The digital packets may include the digital position and/or the additional data. Thus, the remote data concentrators 108 and the remote data concentrators 112 may convert the analog position to digital position and concentrate the digital position and the additional data into the digital packets.

The remote data concentrators 108 and the remote data concentrators 112 may be type-A data concentrators and type-B data concentrators, respectively. For example, the first remote data concentrator 108-1 may be a first type-A remote data concentrator and the second remote data concentrator 108-2 may be a second type-A remote data concentrator. By way of another example, the first remote data concentrator 112-1 may be a first type-b remote data concentrator and the second remote data concentrator 112-2 may be a second type-B remote data concentrator. Type-A data concentrators and type-B data concentrators may include different hardware. Failure of the hardware of Type-A may not cause failure of the hardware of type-B. Thus, a common-mode failure may be mitigated between the remote data concentrators 108 and the remote data concentrators 112. The remote data concentrators 108 of the active sidesticks 102 may both be type-A to provide a common part number for the active sidesticks 102.

The flight control system 100 may include one or more digital buses between the remote data concentrators 108, the remote data concentrators 112, active sidestick computers 110, and/or the flight control computers 114. The remote data concentrators 108 and the remote data concentrators 112 may be connected to the active sidestick computers 110 and the flight control computers 114 by digital buses.

The flight control system 100 may include two of the active sidestick computers 110 and two of the flight control computers 114. For example, the active sidestick computers 110 may include a first active sidestick computer 110-1 within the first active sidestick 102-1 and a second active sidestick computer 110-2 within the second active sidestick 102-2. By way of another example, the flight control computers 114 may include a first flight control computer 114-1 and a second flight control computer 114-2. Multiple of the active sidestick computers 110 and the flight control computers 114 may be utilized in a redundant manner to increase the availability of the flight control system 100 and to ensure safe operation in case of failures of the active sidestick computers 110 and/or the flight control computers 114.

Each of the remote data concentrators 108 and each of the remote data concentrators 112 may send digital packets to each of the active sidestick computers 110 and each of the flight control computers 114. For example, the first remote data concentrator 108-1, the second remote data concentrator 108-2, the first remote data concentrator 112-1, and the second remote data concentrator 112-2 may each send the digital packets to each of the first active sidestick computer 110-1, the second active sidestick computer 110-2, the first flight control computer 114-1, and the second flight control computer 114-2. The active sidestick computers 110 and the flight control computers 114 may receive the digital packets from each of the remote data concentrators 108 and the remote data concentrators 112. For example, the first active sidestick computer 110-1, the second active sidestick computer 110-2, the first flight control computer 114-1, and the second flight control computer 114-2 may each receive the digital packets from each of the first remote data concentrator 108-1, the second remote data concentrator 108-2, the first remote data concentrator 112-1, and the second remote data concentrator 112-2.

The active sidestick computers 110 and the flight control computers 114 may process the digital packets to generate control surface commands. The first active sidestick computer 110-1, the second active sidestick computer 110-2, the first flight control computer 114-1, and the second flight control computer 114-2 may each process the digital packets to generate control surface commands. The active sidestick computers 110 and the flight control computers 114 may process the digital packets to generate the control surface commands by executing a flight control computer function. Each of the active sidestick computers 110 and the flight control computers 114 may execute the flight control computer function.

The active sidestick computers 110 may execute one or more active sidestick computer functions in addition to the flight control computer function. The active sidestick computer functions may include, but is not limited to, causing the control sticks 104 to mimic the motion of the aircraft, program the feel characteristics for the control sticks 104, or the like. The feel characteristics may indicate how hard to pull control sticks 104, include hard stops to prevent stalling the aircraft or going beyond a maximum bank angle, or the like. The active sidestick computers 110 may cause the control sticks 104 to mimic the analog position of the other of the control sticks 104. For example, the first active sidestick computer 110-1 may cause the first control stick 104-1 to mimic the motion of the analog position of the second control stick 104-2. By way of another example, the second active sidestick computer 110-2 may cause the second control stick 104-2 to mimic the motion of the analog position of the first control stick 104-1. The control sticks 104 may automatically move to mimic a flight of the aircraft. The control sticks 104 may mimic the motion of the autopilot or the other active sidestick. For example, the control sticks 104 may move when an autopilot is flying the aircraft to give tactile and visual flight cues of what the autopilot is doing. By way of another example, the control sticks 104 may mimic the movement of the other of the control sticks 104. The first control stick 104-1 may mimic the motion of the second control stick 104-2, and vice versa. The control sticks 104 may emulate a traditional column wheel pedal which are mechanically coupled together between the captain stick and the first officer stick.

The active sidestick computers 110 may include command processors 122, monitor processors 124, and/or comparators 126. The active sidestick computers 110 may include the command processors 122 and the monitor processors 124 in a duplex configuration. For example, the first active sidestick computer 110-1 may include first command processor 122-1, first monitor processor 124-1, and/or first comparator 126-1. By way of another example, the second active sidestick computer 110-2 may include second command processor 122-2, second monitor processor 124-2, and/or second comparator 126-2.

The flight control computers 114 may include command processors 128, monitor processors 130, and/or comparators 132. The flight control computers 114 may include the command processors 128 and the monitor processors 130 in a duplex configuration. For example, the first flight control computer 114-1 may include first command processor 128-1, first monitor processor 130-1, and/or first comparator 132-1. By way of another example, the second flight control computer 114-2 may include second command processor 128-2, second monitor processor 130-2, and/or second comparator 132-2.

The command processors 122, monitor processors 124, command processors 128, and the monitor processors 130 (collectively the processors) may include any one or more processing elements known in the art. In this sense, the processors may include any microprocessor-type device configured to execute software algorithms and/or instructions. The processors may be any device having one or more processing elements, which execute program instructions from memory. For example, the processors may include a multi-core processor, a single-core processor, a reconfigurable logic device (e.g., FPGAs), a digital signal processor (DSP), a special purpose logic device (e.g., ASICs), or other integrated formats. Aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software/and or firmware would be well within the skill of one skilled in the art in light of this disclosure. Such hardware, software, and/or firmware implementation may be a design choice based on various cost, efficiency, or other metrics. In this sense, the processor(s) may include any microprocessor-type device configured to execute software algorithms and/or instructions. In general, the term “processor” may be broadly defined to encompass any device having one or more processing elements, which execute program instructions from memory, from firmware, or by hardware implemented functions. It should be recognized that the steps described throughout the present disclosure may be carried out by the processors.

The command processors 122, the monitor processors 124, the command processors 128, and the monitor processors 130 may be type-A processors, type-B processors, type-C processors, and type-D processors, respectively. For example, the first command processor 122-1 and the second command processor 122-2 may be a first type-A processor and a second type-A processor, respectively. By way of another example, the first monitor processor 124-1 and the second monitor processor 124-2 may be a first type-B processor and a second type-B processor, respectively. By way of another example, the first command processor 128-1 and the second command processor 128-2 may be a first type-C processor and a second type-C processor, respectively. By way of another example, the first monitor processor 130-1 and the second monitor processor 130-2 may be a first type-D processor and a second type-D processor, respectively. Type-A processors, type-B processors, type-C processors, and type-D processors may include different processor architectures. Failure of the hardware of type-A processors, type-B processors, type-C processors, and/or type-D processors may not cause failure of the processors of the other types. Thus, a common-mode failure may be mitigated between the command processors 122, the monitor processors 124, the command processors 128, and the monitor processors 130. Each of the command processors 122, the monitor processors 124, the command processors 128, and the monitor processors 130 may be dissimilar to substantially reduce the occurrence of common mode and random failures. The computation functions may be implemented with dissimilar hardware which provides mitigation for common mode hardware failures.

Although the command processors 122, the monitor processors 124, the command processors 128, and the monitor processors 130 are described as type-A processors, type-B processors, type-C processors, and type-D processors, respectively, this is not intended as a limitation of the present disclosure. It is contemplated that one or more of the command processors 122, the monitor processors 124, the command processors 128, and/or the monitor processors 130 may share a processor architecture. For example, the command processors 122 and the monitor processors 124 may share a processor architecture. In this example, the command processors 122 and the monitor processors 124 may each be type-A processors. By way of another example, the command processors 128 and/or the monitor processors 130 may share a processor architecture. In this example, the command processors 128 and the monitor processors 130 may each be type-B processors.

The command processors 122 and/or the monitor processors 124 may process the digital packets to generate the control surface commands. The command processors 122 and/or the monitor processors 124 may execute the flight control computer function for the active sidestick computers 110. The monitor processors 124 may duplicate the functions of the command processors 122 or may perform some other computation to monitor the command processors 122. Similarly, the command processors 128 and/or the monitor processors 130 may execute the flight control computer function for the flight control computers 114. The monitor processors 130 may duplicate the functions of the command processors 128 or perform some other computation to monitor the command processors 128.

The flight control computer function may include one or more aircraft level control laws. The flight control computer function may determine control surface commands from the digital packets (e.g., from the digital position of the control sticks 104 and the additional data). In this regard, each of the command processors 122, the monitor processors 124, the command processors 128, and/or the monitor processors 130 may determine control surface commands from the digital packets. For example, the first command processor 122-1, the second command processor 122-2, the first monitor processor 124-1, the second monitor processor 124-2, the first command processor 128-1, the second command processor 128-2, the first monitor processor 130-1, and/or the second monitor processor 130-2 may determine control surface commands from the digital packets.

A processor may be considered a “command” processor in that the command processors may output the control surface commands (e.g., output from the active sidestick computers 110 and/or from the flight control computers 114). The active sidestick computers 110 and/or the flight control computers 114 may output the control surface commands generated by the command processors to the remote electronic units (e.g., the remote electronic units 116 and/or the remote electronic units 118).

A processor may be considered a “monitor” processor in that the processors do not output (e.g., do not output from the flight control computers 114 and/or from the flight control computers 114) the control surface commands. The active sidestick computers 110 and/or from the flight control computers 114 may not output the control surface commands generated by the monitor processors. Although the monitor processors 124 and the monitor processors 130 are described as not outputting the control surface commands, this is not intended as a limitation of the present disclosure. It is contemplated that the monitor processors 124 and/or the monitor processors 130 may output the control surface commands.

The comparators (e.g., the comparators 126 and/or the comparators 132) may compare the control surface commands generated by the command processors (e.g., the command processors 122 and/or the command processors 128) and generated by the monitor processors (e.g., the monitor processors 124 and/or the monitor processors 130). The comparators 126 may compare the control surface commands generated by the command processors 122 and generated by the monitor processors 124. For example, the first comparator 126-1 may compare the control surface commands generated by the first command processor 122-1 and generated by the first monitor processor 124-1. By way of another example, the second comparator 126-2 may compare the control surface commands generated by the second command processor 122-2 and generated by the second monitor processor 124-2. Similarly, he comparators 132 may compare the control surface commands generated by the command processors 128 and generated by the monitor processors 130. For example, the first comparator 132-1 may compare the control surface commands generated by the first command processor 128-1 and generated by the first monitor processor 130-1. By way of another example, the second comparator 132-2 may compare the control surface commands generated by the second command processor 128-2 and generated by the second monitor processor 130-2.

The comparators may compare the control surface commands generated by the command processors and generated by the monitor processors to determine a valid-compare and/or a mis-compare. A valid-compare may occur when the control surface commands generated by the command processors agree with the control surface commands generated by the monitor processors. A mis-compare may occur when the control surface commands generated by the command processors do not agree with the control surface commands generated by the monitor processors. The comparators may compare the control surface commands using a voting process or the like.

Upon determining the valid-compare, the comparators (e.g., the comparators 126 and/or the comparators 132) may switch closed the output from the command processors (e.g., the command processors 122 and/or the command processors 128) such that the command processors output the control surface commands. The first active sidestick computer 110-1, the second active sidestick computer 110-2, the first flight control computer 114-1, and the second flight control computer 114-2 are configured to output the control surface commands generated by the command processors (e.g., the command processors 122, the command processors 128) upon determining the valid-compare.

Upon determining the mis-compare, the comparators (e.g., the comparators 126 and/or the comparators 132) may switch open the output from the command processors (e.g., the command processors 122 and/or the command processors 128) such that the command processors do not output the control surface commands to the remote electronic units. The first active sidestick computer 110-1, the second active sidestick computer 110-2, the first flight control computer 114-1, and the second flight control computer 114-2 will not output the control surface commands generated by the command processors (e.g., the command processors 122, the command processors 128) upon determining the mis-compare. In some embodiments, the control surface commands may be output but flagged as invalid.

The command processors (e.g., the command processors 122 and/or the command processors 128) and the monitor processors (e.g., the monitor processors 124 and/or the monitor processors 130) may receive feedback of whether the output from the command processors are closed or open. The command processors 122 and the monitor processors 124 may receive feedback of whether the output from the command processors 122 are closed or open. For example, the first command processor 122-1 and the first monitor processor 124-1 may receive feedback of whether the output from the first monitor processor 124-1 is closed or open. By way of another example, the second command processor 122-2 and the second monitor processor 124-2 may receive feedback of whether the output from the second monitor processor 124-2 is closed or open. Similarly, the command processors 128 and the monitor processors 130 may receive feedback of whether the output from the command processors 128 are closed or open. For example, the first command processor 128-1 and the first monitor processor 130-1 may receive feedback of whether the output from the first command processor 128-1 is closed or open. By way of another example, the second command processor 128-2 and the second monitor processor 130-2 may receive feedback of whether the output from the second command processor 128-2 is closed or open.

The active sidestick computers 110 and/or the flight control computers 114 may be the primary control path for the remote electronic units 116 and/or the remote electronic units 118. The primary control path may have safety or reliability that is at a higher level than a secondary control path. The primary control path may have more processing functions than a secondary control path. The primary control path may always be on so long as the valid-compare is detected.

The remote electronic units 116 and/or the remote electronic units 118 may be located on or near the actuators of the control surfaces 120. The remote electronic units 116 and/or the remote electronic units 118 may be an integral part of the actuators of the control surfaces 120, a line-replaceable unit (“LRU”) mounted on the actuators of the control surfaces 120, or a unit mounted near the control surfaces 120. The remote electronic units 116 and/or the remote electronic units 118 may be considered “remote” in that the remote electronic units 116 and/or the remote electronic units 118 may not be within a cockpit near the active sidestick computers 110 and/or the flight control computers 114.

The flight control system 100 may include one or more digital buses between the active sidestick computers 110, the flight control computers 114, the remote electronic units 116, and/or the remote electronic units 118. The active sidestick computers 110 and/or the flight control computers 114 may be connected to the remote electronic units 116 and/or the remote electronic units 118 by digital buses.

The remote electronic units 116 may include first remote electronic unit 116-1, second remote electronic unit 116-2, third remote electronic unit 116-3, fourth remote electronic unit 116-4, and the like.

The remote electronic units 118 may include first remote electronic unit 118-1, second remote electronic unit 118-2, third remote electronic unit 118-3, fourth remote electronic unit 118-4, and the like.

The active sidestick computers 110 and the flight control computers 114 may send the control surface commands to the remote electronic units (e.g., the remote electronic units 116 and/or the remote electronic units 118) upon determining the valid-compare. The active sidestick computers 110 may send the control surface commands to one or more of the remote electronic units 116. Similarly, the flight control computers 114 may send the control surface commands to one or more of the remote electronic units 118. In particular, the command processors 122 of the active sidestick computers 110 and the command processors 128 of the flight control computers 114 may send the control surface commands to the remote electronic units (e.g., the remote electronic units 116 and/or the remote electronic units 118) upon determining the valid-compare. Each of the command processors 122 and/or the command processors 128 may send the control surface commands to one or more of the remote electronic units 116 and/or the remote electronic units 118. For example, the first command processor 122-1 of the first active sidestick computer 110-1 may send the control surface commands to the first remote electronic unit 116-1 and the second remote electronic unit 116-2. By way of another example, the second command processor 122-2 of the second active sidestick computer 110-2 may send the control surface commands to the third remote electronic unit 116-3 and the fourth remote electronic unit 116-4. By way of another example, the first command processor 128-1 of the first flight control computer 114-1 may send the control surface commands to the first remote electronic unit 118-1 and the third remote electronic unit 118-3. By way of another example, the second command processor 128-2 of the second flight control computer 114-2 may send the control surface commands to the second remote electronic unit 118-2 and the fourth remote electronic unit 118-4.

The control surface commands may be sent directly from the active sidestick computers 110 and the flight control computers 114 to the remote electronic units 116 and the remote electronic units 118. For example, the control surface commands may be sent directly from the active sidestick computers 110 and the flight control computers 114 to the remote electronic units 116 and the remote electronic units 118 without passing through the remote data concentrators 108 and/or the remote data concentrators 112.

Pairs of the remote electronic units 116 and/or the remote electronic units 118 may receive the control surface commands from respective of the active sidestick computers 110 and the flight control computers 114. For example, the first remote electronic unit 116-1 and the first remote electronic unit 118-1 may receive the control surface commands from the first active sidestick computer 110-1 and the first flight control computer 114-1, respectively. By way of another example, the second remote electronic unit 116-2 and the second remote electronic unit 118-2 may receive the control surface commands from the first active sidestick computer 110-1 and the second flight control computer 114-2, respectively. By way of another example, the third remote electronic unit 116-3 and the third remote electronic unit 118-3 may receive the control surface commands from the second active sidestick computer 110-2 and the first flight control computer 114-1, respectively. By way of another example, the fourth remote electronic unit 116-4 and the fourth remote electronic unit 118-4 may receive the control surface commands from the second active sidestick computer 110-2 and the second flight control computer 114-2, respectively. Thus, the remote electronic units 116 and the remote electronic units 118 may receive the control surface commands from type-A computers (e.g., the active sidestick computers 110) and type-B computers (e.g., the flight control computers 114), respectively. Failure of the type-A or type-B computers may not cause both of the remote electronic units 116 and the remote electronic units 118 associated with the control surfaces 120, to fail to receive the control surface commands. Thus, a common-mode failure may be mitigated.

The remote electronic units 116 and the remote electronic units 118 may be type-A remote electronic units and type-B remote electronic units, respectively. For example, the first remote electronic unit 116-1, the second remote electronic unit 116-2, the third remote electronic unit 116-3, and the fourth remote electronic unit 116-4 may be a first type-A remote electronic unit, a second type-A remote electronic unit, a third type-A remote electronic unit, and a fourth type-A remote electronic unit, respectively. By way of another example, the first remote electronic unit 118-1, the second remote electronic unit 118-2, the third remote electronic unit 118-3, the fourth remote electronic unit 118-4 may be a first type-B remote electronic unit, a second type-B remote electronic unit, a third type-B remote electronic unit, and a fourth type-B remote electronic unit, respectively. Type-A data remote electronic units and type-B data remote electronic units may include different hardware. Failure of the hardware of Type-A may not cause failure of the hardware of type-B. Thus, a common-mode failure may be mitigated between the remote electronic units 116 and the remote electronic units 118.

The remote electronic units 116 and the remote electronic units 118 may determine if the control surface commands are valid.

The remote electronic units 116 and the remote electronic units 118 may drive the control surfaces 120 based on the control surface commands. Pairs of the remote electronic units 116 and the remote electronic units 118 may drive respective of the control surfaces 120 based on the control surface commands. For example, the first remote electronic unit 116-1 and the first remote electronic unit 118-1 may drive the first control surface 120-1 based on the control surface commands. By way of another example, the second remote electronic unit 116-2 and the second remote electronic unit 118-2 may drive the second control surface 120-2 based on the control surface commands. By way of another example, the third remote electronic unit 116-3 and the third remote electronic unit 118-3 may drive the third control surface 120-3 based on the control surface commands. By way of another example, the fourth remote electronic unit 116-4 and the fourth remote electronic unit 118-4 may drive the fourth control surface 120-4 based on the control surface commands.

The control surfaces 120 may include the first control surface 120-1, the second control surface 120-2, the third control surface 120-3, the fourth control surface 120-4, and the like. Each control surface 120 is intended to include one or more actuators necessary to control the movement of the control surface 120. For example, when the remote electronics unit 116 is connected to the control surface 120, the remote electronics unit is physically connected to the actuator of the control surface 120.

The control surfaces 120 may be connected to pairs of the remote electronic units 116 and the remote electronic units 118. For example, the first control surface 120-1 may be connected to the first remote electronic unit 116-1 and the first remote electronic unit 118-1. By way of another example, the second control surface 120-2 may be connected to the second remote electronic unit 116-2 and the second remote electronic unit 118-2. By way of another example, the third control surface 120-3 may be connected to the third remote electronic unit 116-3 and the third remote electronic unit 118-3. By way of another example, the fourth control surface 120-4 may be connected to the fourth remote electronic unit 116-4 and the fourth remote electronic unit 118-4. Thus, each of the control surfaces 120 may be coupled to one of the type-A remote electronic units and one of the type-B remote electronic units.

Each of the remote electronic units 116 and the remote electronic units 118 may include a digital-to-analog converter (DAC) (not depicted) configured to receive the control surface commands and convert the control surface commands to an analog signal. The converted analog signal may be transmitted via one or more relays (not shown) and amplified via one or more amplifiers (not shown) before being transmitted to a corresponding of the actuator of the control surfaces 120.

The control surfaces 120 may be control surfaces of the aircraft. The control surfaces 120 may include any device designed to influence an attitude or trajectory of, or supply lift or drag to the aircraft. The control surfaces 120 may control movement of the aircraft in one or more of the three angles of the aircraft (yaw angle (w), pitch angle (0), roll angle (q)). The control surfaces 120 may include elevators, ailerons, rudders, flaps, slats, spoilers, trims, speed brakes, and the like.

Each of the actuators of the control surfaces 120 may be controlled by an electric signal. The electrical signal may be the analog signal received from the corresponding of the remote electronic units 116 and the remote electronic units 118. The actuators of the control surfaces 120 may transform the analog signal received into motion, which may be used to manipulate a corresponding aircraft flight control surface.

The control surfaces 120 may include one or more actuators. The actuators may be servo valve-controlled linear cylinder, a high-speed rotary motor driving a reduction gear, an electromechanical actuator, or other actuation devices. The control surfaces 120 may each include two of the actuators. In a nominal case, the control surfaces 120 includes two of the actuators with one of the actuators driven by the remote electronic units 116 and the other of the actuators driven by the remote electronic units 118. For example, the control surfaces 120 with two of the actuators may be an aileron, a flap, an elevator, or the like.

Although the control surfaces 120 are described as including two of the actuators, this is not intended as a limitation of the present disclosure. It is further contemplated that the flight control system 100 may include a single actuator within the control surfaces 120 controlled by a of the single remote electronic units 116 or a single of the remote electronic units 118. For example, the control surfaces 120 with a single actuator may be a spoiler interface. It is also contemplated that a control surface 120 with a single actuator may be controlled by both the remote electronics unit 116 and the remote electronics unit 118—for example, using a flux summed valve.

It is further contemplated that the control surfaces 120 may include three of the actuators with one of the actuators driven by the remote electronic units 116 and the other of the actuators driven by the remote electronic units 118, and a third of the actuators driven by either the remote electronic units 116 or the remote electronic units 118. For example, the control surfaces 120 with three of the actuators may be a rudder.

The control surfaces 120 may further include a sensor, such as a potentiometer or differential voltage transducer, configured to transmit feedback signals to the remote electronic units 116 and/or the remote electronic units 118. The feedback signals may report the position of the control surfaces 120 and/or the position of the actuators of the control surfaces 120. The transmitted signal provides the remote electronic units 116 and/or the remote electronic units 118 with a reference to determine when the control surfaces 120 have reached the desired position. The remote electronic units 116 and the remote electronic units 118 may perform loop closure of the control surfaces 120. The remote electronic units 116 may perform the loop closure using the control surface commands and the analog feedback. In the case of a control algorithm, one or more program instructions or methods may be configured to operate via proportional control, feedback control, feedforward control, integral control, proportional-derivative (PD) control, proportional-integral (PI) control, proportional-integral-derivative (PID) control, or the like.

It is contemplated that the generation of the control surface commands using the active sidestick computer 110 may create a highly integrated system of control, reducing the size, weight, or power (SWAP-C) and/or wire weight of the aircraft, reduce the number of ACEs and flight control computers, and the like.

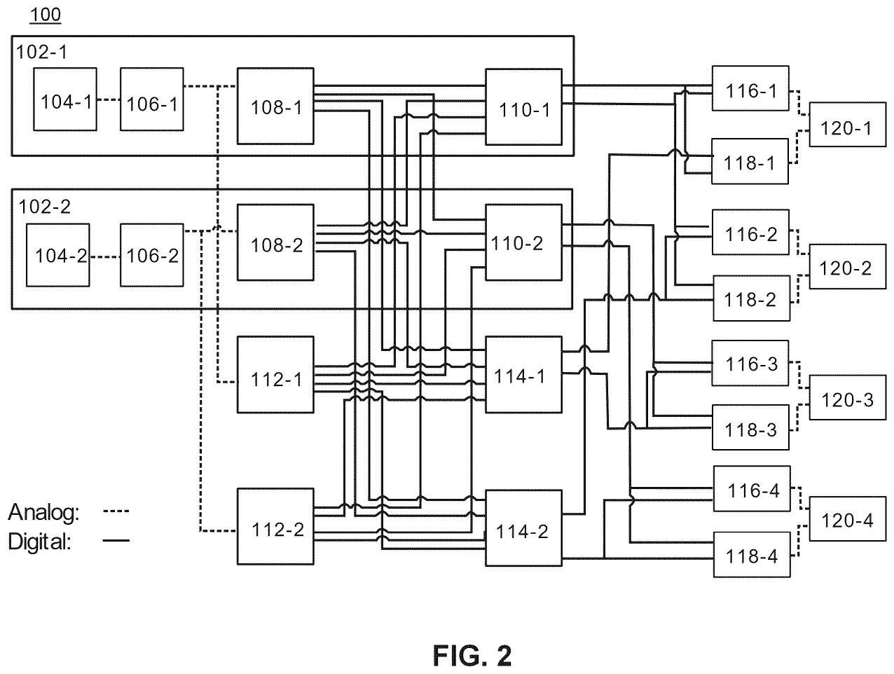

FIG. 2 depicts the flight control system 100, in accordance with one or more embodiments of the present disclosure. Although the remote electronic units 116 and the remote electronic units 118 are described as receiving one input, this is not intended as a limitation of the present disclosure. It is contemplated that the remote electronic units 116 and/or the remote electronic units 118 may receive the control surface commands from two or more computers. The remote electronic units 116 and/or the remote electronic units 118 may receive the control surface commands from one or more of the active sidestick computers 110 and from one or more of the flight control computers 114. For example, the pairs of the remote electronic units 116 and/or the remote electronic units 118 may share inputs from the active sidestick computers 110 and the flight control computers 114.

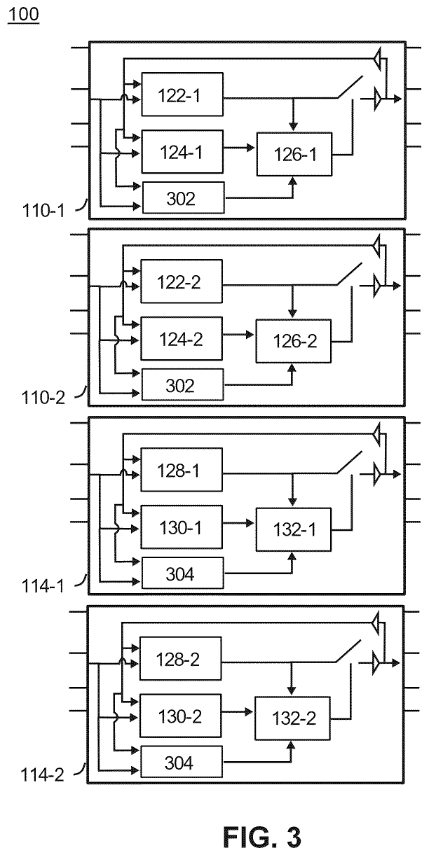

FIG. 3 depicts the flight control system 100, in accordance with one or more embodiments of the present disclosure. Although the active sidestick computers 110 are described as including the command processors 122 and the monitor processors 124 in the duplex configuration, this is not intended as a limitation of the present disclosure. It is further contemplated that the active sidestick computers 110 may include the command processors 122, the monitor processors 124, and one or more additional processors 302 in a triplex configuration. The one or more additional processors 302 may include a same processor architecture or a different processor architecture than the command processors 122 and/or than the monitor processors 124. The comparators 126 may compare the outputs from the command processors 122, the monitor processors 124, and the one or more additional processors 302 using a voting process to determine the valid-compare or the mis-compare.

Similarly, although the flight control computers 114 are described including the command processors 128 and the monitor processors 130 in the duplex configuration, this is not intended as a limitation of the present disclosure. The flight control computers 114 may include the command processors 128, the monitor processors 130, and one or more additional processors 304 in a triplex configuration. The one or more additional processors 304 may include a same processor architecture or a different processor architecture than the command processors 128 and/or than the monitor processors 130. The comparators 132 may compare the outputs from the command processors 128, the monitor processors 130, and the one or more additional processors 304 using a voting process to determine the valid-compare or the mis-compare.

Thus, the active sidestick computers 110 and/or the flight control computers 114 may include a duplex configuration and/or a triplex configuration. The flight control system 100 may include various permutations of the active sidestick computers 110 and/or the flight control computers 114 in the duplex configuration and/or in the triplex configuration. For example, each of the active sidestick computers 110 and/or the flight control computers 114 may be in the duplex configuration. By way of another example, each of the active sidestick computers 110 and/or the flight control computers 114 may be in the triplex configuration. By way of another example, one or more of the active sidestick computers 110 may be in the duplex configuration and one or more of the flight control computers 114 may be in the triplex configuration. By way of another example, one or more of the active sidestick computers 110 may be in the triplex configuration and one or more of the flight control computers 114 may be in the duplex configuration. The active sidestick computers 110 may or may not include the same configuration. For example, one of the active sidestick computers 110 may be in the duplex configuration and the other of the active sidestick computers 110 be in the triplex configuration. Similarly, the flight control computers 114 may or may not include the same configuration. For example, one of the flight control computers 114 may be in the duplex configuration and the other of the flight control computers 114 be in the triplex configuration.

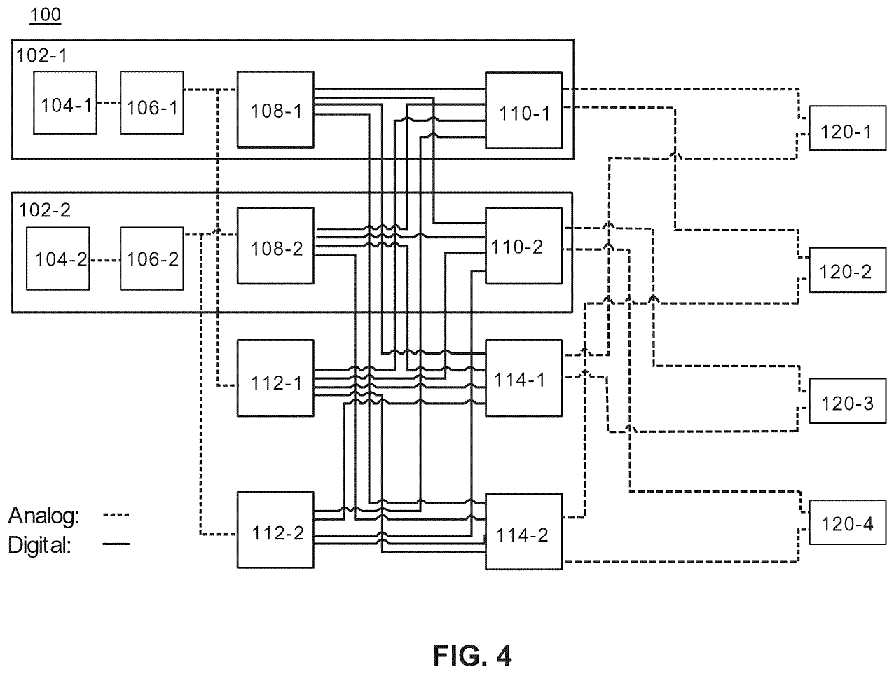

FIG. 4 depicts the flight control system 100, in accordance with one or more embodiments of the present disclosure. Although the flight control system 100 is described and depicted as including the remote electronic units 116 and the remote electronic units 118, this is not intended as a limitation of the present disclosure. The function of the remote electronic units 116 and the remote electronic units 118 may be integrated into the active sidesticks 102, the remote data concentrators 108, the active sidestick computers 110, the remote data concentrators 112, the flight control computers 114, or any combination thereof. The active sidesticks 102, the remote data concentrators 108, the active sidestick computers 110, the remote data concentrators 112, the flight control computers 114 may provide analog signals to control the actuators of the control surfaces 120 directly. The flight control system 100 may include one or more analog buses connecting between the active sidesticks 102, the remote data concentrators 108, the active sidestick computers 110, the remote data concentrators 112, and/or the flight control computers 114 and the control surfaces 120. For example, the active sidestick computers 110 and the flight control computers 114 may drive the control surfaces 120 based on the control surface commands.

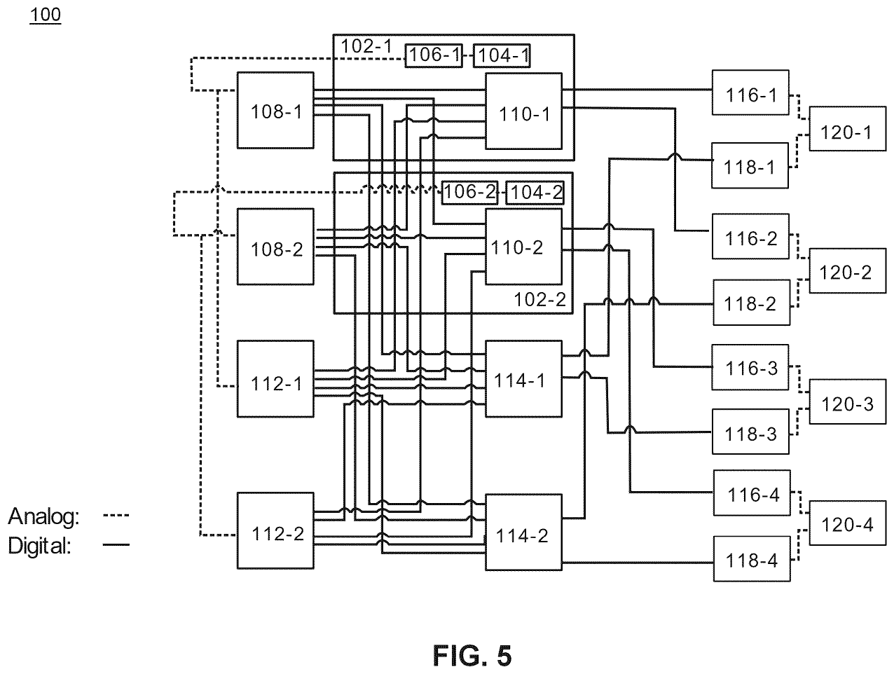

FIG. 5 depicts the flight control system 100, in accordance with one or more embodiments of the present disclosure. Although the active sidesticks 102 are described as including the remote data concentrators 108, this is not intended as a limitation of the present disclosure. The remote data concentrators 108 may be disposed outside of the active sidesticks 102. The remote data concentrators 108 may still receive the data from the pilot sensors 106. The remote data concentrators 108 may also provide the digital packets to the various computers. The remote data concentrators 108 may be line-replaceable units (LRU) disposed outside of the active sidesticks 102.

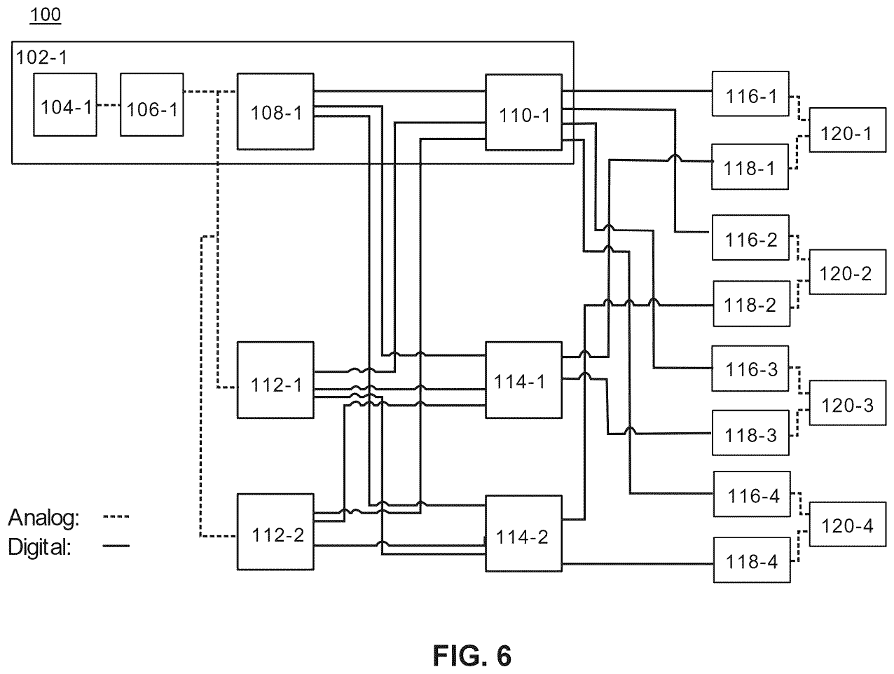

FIG. 6 depicts the flight control system 100, in accordance with one or more embodiments of the present disclosure. Although the flight control system 100 is described as including the second active sidestick 102-2, this is not intended as a limitation of the present disclosure. The flight control system 100 may include only the first active sidestick 102-1. For example, the flight control system 100 may include only the first active sidestick 102-1 where the aircraft is a single pilot aircraft.

Referring generally again to the figures.

Any of the various digital buses may include a data bus transmission media, such as, but not limited to, ARINC429, CAN bus, RS-485, or their derivatives.

The remote data concentrators 108 and/or the remote data concentrators 112 may or may not provide a backup mode. It is contemplated that the remote data concentrators 108 and/or the remote data concentrators 112 may not provide the backup mode because the active sidestick computers 110 and the flight control computers 114 are implemented with different processor architectures. Thus, the active sidestick computers 110 may eliminate the need for a backup mode which will further reduce cost and complexity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period. For example, the memory may be random access memory (RAM), and the results may not necessarily persist indefinitely in the memory.

It is noted herein that the one or more components of system may be communicatively coupled to the various other components of system in any manner known in the art. For example, the one or more processors may be communicatively coupled to each other and other components via a wireline connection or wireless connection.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A flight control system comprising:
a first active sidestick comprising:
a first control stick;
a first pilot sensor configured to sense a first analog position of the first control stick; and
a first active sidestick computer;
a second active sidestick comprising:
a second control stick;
a second pilot sensor configured to sense a second analog position of the second control stick; and
a second active sidestick computer;
a first flight control computer; and
a second flight control computer, wherein the first active sidestick computer, the second active sidestick computer, the first flight control computer, and the second flight control computer are configured to receive one or more digital packets and process the one or more digital packets to generate one or more control surface commands.

2. The flight control system of claim 1, comprising:
a first type-A remote data concentrator;
a first type-B remote data concentrator;
a second type-A remote data concentrator; and
a second type-B remote data concentrator, wherein the first type-A remote data concentrator, the second type-A remote data concentrator, the first type-B remote data concentrator, and the second type-B remote data concentrator are configured to convert the first analog position of the first control stick and the second analog position of the second control stick to digital positions and concentrate the digital positions into the one or more digital packets.

3. The flight control system of claim 2, wherein the first type-A remote data concentrator, the second type-A remote data concentrator, the first type-B remote data concentrator, and the second type-B remote data concentrator are configured to send the one or more digital packets to the first active sidestick computer, the second active sidestick computer, the first flight control computer, and the second flight control computer.

4. The flight control system of claim 3, wherein the first active sidestick comprises the first type-A remote data concentrator; wherein the second active sidestick comprises the second type-A remote data concentrator.

5. The flight control system of claim 4, wherein the first type-B remote data concentrator and the second type-B remote data concentrator are disposed outside of the first active sidestick and the second active sidestick.

6. The flight control system of claim 3, wherein the first pilot sensor and the second pilot sensor are configured to send the first analog position of the first control stick and the second analog position of the second control stick, respectively, to each of the first type-A remote data concentrator, the second type-A remote data concentrator, the first type-B remote data concentrator, and the second type-B remote data concentrator.

7. The flight control system of claim 6, wherein the first type-A remote data concentrator, the second type-A remote data concentrator, the first type-B remote data concentrator, and the second type-B remote data concentrator are configured to receive additional data and concentrate the additional data into the one or more digital packets.

8. The flight control system of claim 1, wherein the first active sidestick computer, the second active sidestick computer, the first flight control computer, and the second flight control computer each comprise a command processor and a monitor processor, wherein the command processor and the monitor processor are configured to process the one or more digital packets to generate the one or more control surface commands.

9. The flight control system of claim 8, wherein the command processor of the first active sidestick computer and the second active sidestick computer are type-A processors, wherein the monitor processor of the first active sidestick computer and the second active sidestick computer are type-B processors, wherein the command processor of the first flight control computer and the second flight control computer are type-C processors, wherein the monitor processor of the first flight control computer and the second flight control computer are type-D processors.

10. The flight control system of claim 8, wherein the command processor of the first active sidestick computer and the second active sidestick computer and the monitor processor of the first active sidestick computer and the second active sidestick computer are type-A processors, wherein the command processor of the first flight control computer and the second flight control computer and the monitor processor of the first flight control computer and the second flight control computer are type-B processors.

11. The flight control system of claim 8, wherein at least one of the first active sidestick computer, the second active sidestick computer, the first flight control computer, or the second flight control computer comprise an additional processor, wherein the command processor, the monitor processor, and the additional processor are in a triplex configuration.

12. The flight control system of claim 8, wherein the first active sidestick computer, the second active sidestick computer, the first flight control computer, and the second flight control computer each include a comparator; wherein the comparator is configured to compare the one or more control surface commands generated by the command processor and the monitor processor to determine one of a valid-compare or a mis-compare.

13. The flight control system of claim 12, wherein the first active sidestick computer, the second active sidestick computer, the first flight control computer, and the second flight control computer are configured to output the one or more control surface commands generated by the command processor upon determining the valid-compare.

14. The flight control system of claim 13, wherein the first active sidestick computer, the second active sidestick computer, the first flight control computer, and the second flight control computer do not output the one or more control surface commands generated by the command processor upon determining the mis-compare.

15. The flight control system of claim 12, wherein the comparator is configured to switch open an output from the command processor upon determining the mis-compare and switch closed the output from the command processor upon determining the valid-compare.

16. The flight control system of claim 1, comprising:
a plurality of type-A remote electronic units, wherein the plurality of type-A remote electronic units are configured to receive the one or more control surface commands from at least one of the active sidestick computers or the flight control computers;
a plurality of type-B remote electronic units, wherein the plurality of type-B remote electronic units are configured to receive the one or more control surface commands from at least one of the active sidestick computers or the flight control computers; and
a plurality of control surfaces, wherein the plurality of type-A remote electronic units and of the plurality of type-B remote electronic units are configured to drive actuators of the plurality of control surfaces based on the one or more control surface commands.

17. The flight control system of claim 16, wherein the first active sidestick computer and the second active sidestick computer are configured to send the one or more control surface commands to one or more of the plurality of type-A remote electronic units; wherein the first flight control computer and the second flight control computer are configured to send the one or more control surface commands to one or more of the plurality of type-B remote electronic units.

18. The flight control system of claim 16, wherein the actuators of the plurality of control surfaces are driven by one or more of the plurality of type-A remote electronic units or one or more of the plurality of type-B remote electronic units.

19. The flight control system of claim 1, comprising a plurality of control surfaces, wherein the active sidestick computers and the flight control computers are configured to drive actuators of the plurality of control surfaces based on the one or more control surface commands.

20. A flight control system comprising:
a first active sidestick comprising:
a first control stick;
a first pilot sensor configured to sense a first analog position of the first control stick; and
a first active sidestick computer;
a second active sidestick comprising:
a second control stick;
a second pilot sensor configured to sense a second analog position of the second control stick; and
a second active sidestick computer;
a first flight control computer;
a second flight control computer, wherein the first active sidestick computer, the second active sidestick computer, the first flight control computer, and the second flight control computer are configured to receive one or more digital packets and process the one or more digital packets to generate one or more control surface commands;
a first type-A remote data concentrator;
a first type-B remote data concentrator;
a second type-A remote data concentrator;
a second type-B remote data concentrator, wherein the first type-A remote data concentrator, the second type-A remote data concentrator, the first type-B remote data concentrator, and the second type-B remote data concentrator are configured to convert the first analog position of the first control stick and the second analog position of the second control stick to digital positions and concentrate the digital positions into the one or more digital packets;
a plurality of type-A remote electronic units;
a plurality of type-B remote electronic units, wherein pairs of the plurality of type-A remote electronic units and of the plurality of type-B remote electronic units are configured to receive the one or more control surface commands from respective of the active sidestick computers and the flight control computers; and
a plurality of control surfaces, wherein the pairs of the plurality of type-A remote electronic units and of the plurality of type-B remote electronic units are configured to drive actuators of respective of the plurality of control surfaces based on the one or more control surface commands.
